(19) United States
(12) Patent Application Publication
(10) Pub. No.: US 2024/0340772 A1
(43) Pub. Date: Oct. 10, 2024

(54) STEERING OF ROAMING ENHANCEMENT DURING REGISTRATION REJECT

(71) Applicant: Nokia Technologies Oy, Espoo (FI)

(72) Inventors: Saurabh KHARE, Bangalore (IN); Pallab GUPTA, Bangalore (IN); Ranganathan MAVUREDDI DHANASEKARAN, Munich (DE)

(21) Appl. No.: 18/295,507

(22) Filed: Apr. 4, 2023

(51) Int. Cl. H04W 48/14; H04W 12/041; H04W 12/106; H04W 60/04

(52) U.S. Cl. CPC H04W 48/14; H04W 12/041; H04W 12/106; H04W 60/04; H04W 84/042

(57) ABSTRACT

Embodiments of the present disclosure relate to devices, methods, apparatuses and computer readable storage media of Steering of Roaming (SoR) enhancement during registration reject. The method comprises transmitting, from a terminal device to an AMF, a registration request at least indicating that a SoR update is supported in a registration reject message, the AMF being associated with a VPLMN on which the terminal device intends to camp; and receiving the registration reject message including a request of acknowledgement, SoR information and a MAC-I of a home network.

### FIELD

Embodiments of the present disclosure generally relate to the field of telecommunication and in particular to devices, methods, apparatuses and computer readable storage media of Steering of Roaming (SoR) enhancement during registration reject.

### BACKGROUND

Roaming Value Added Services (RVAS) form part of the roaming services ecosystem and has been discussed within Global System for Mobile Communication Association (GSMA). RVAS can be provided by either the public land mobile network (PLMN) or outsourced to a fully trusted entity by the PLMN on behalf it is acting like a RVAS provider, Internet Protocol Exchange (IPX) provider or Roaming Hubbing provider. The RVAS are consumed by roaming subscribers or by the home network of the roaming subscribers.

### SUMMARY

In general, example embodiments of the present disclosure provide a solution of SoR enhancement during registration reject.

In a first aspect, there is provided an apparatus. The apparatus comprises at least one processor; and at least one memory storing instructions that, when executed by the at least one processor, cause the apparatus at least to transmit, to an access and mobility management function (AMF), a registration request at least indicating that a SoR update is supported in a registration reject message, the AMF being associated with a visited public land mobile network (VPLMN) on which the apparatus intends to camp; and receive the registration reject message including a request of acknowledgement, SoR information and a message authentication code-integrity (MAC-I) of a home network.

In a second aspect, there is provided an apparatus. The apparatus comprises at least one processor; and at least one memory storing instructions that, when executed by the at least one processor, cause the apparatus at least to receive, from a terminal device, a registration request at least indicating that a SoR update is supported in a registration reject message, the apparatus being associated with a VPLMN on which the terminal device intends to camp; and provide, to a unified data management (UDM) function, an indication that the SoR update is supported in the registration reject message.

In a third aspect, there is provided an apparatus. The apparatus comprises at least one processor; and at least one memory storing instructions that, when executed by the at least one processor, cause the apparatus at least to receive, from an AMF an indication that a SoR update is supported in the registration reject message, the AMF being associated with a VPLMN on which the terminal device intends to camp; and determine that the registration reject message is to be transmitted to the terminal device.

In a fourth aspect, there is provided an apparatus. The apparatus comprises at least one processor; and at least one memory storing instructions that, when executed by the at least one processor, cause the apparatus at least to receive, from a UDM function, that an indication that a SoR update is supported in the registration reject message; and in accordance with a determination that the registration reject message is to be transmitted to a terminal device, provide, to the UDM, at least one recommended VPLMN to be camped on by the terminal device.

In a fifth aspect, there is provided an apparatus. The apparatus comprises at least one processor; and at least one memory storing instructions that, when executed by the at least one processor, cause the apparatus at least to transmit, to an AMF, an authentication response including a request of acknowledgement, SoR information and a MAC-I of a home network.

In a sixth aspect, there is provide a method. The method comprises transmitting, from a terminal device to an AMF, a registration request at least indicating that a SoR update is supported in a registration reject message, the AMF being associated with a VPLMN on which the terminal device intends to camp; and receiving the registration reject message including a request of acknowledgement, SoR information and a MAC-I of a home network.

In a seventh aspect, there is provide a method. The method comprises receiving, at an AMF and from a terminal device, a registration request at least indicating that a SoR update is supported in a registration reject message, the AMF being associated with a VPLMN on which the terminal device intends to camp; and providing, to a UDM function, an indication that the SoR update is supported in the registration reject message.

In an eighth aspect, there is provide a method. The method comprises receiving, at a UDM and from an AMF, an indication that a SoR update is supported in the registration reject message, the AMF being associated with a VPLMN on which the terminal device intends to camp; and determining that the registration reject message is to be transmitted to the terminal device.

In a ninth aspect, there is provide a method. The method comprises receiving, at a SoR application and from a UDM function, an indication that a SoR update is supported in the registration reject message; and in accordance with a determination that the registration reject message is to be transmitted to a terminal device, providing, to the UDM, at least one recommended VPLMN to be camped on by the terminal device.

In a tenth aspect, there is provide a method. The method comprises transmitting, from an AUSF to an AMF, an authentication response including a request of acknowledgement, SoR information and a MAC-I of a home network.

In an eleventh aspect, there is provided an apparatus comprising means for transmitting, to an AMF, a registration request at least indicating that a SoR update is supported in a registration reject message, the AMF being associated with a VPLMN on which the apparatus intends to camp; and means for receiving the registration reject message including a request of acknowledgement, SoR information and a MAC-I of a home network.

In a twelfth aspect, there is provided an apparatus comprising means for receiving, from a terminal device, a registration request at least indicating that a SoR update is supported in a registration reject message, the apparatus being associated with a VPLMN on which the terminal device intends to camp; and means for providing, to a UDM function, an indication that the SoR update is supported in the registration reject message.

In a thirteenth aspect, there is provided an apparatus comprising means for receiving, from an AMF, an indication that a SoR update is supported in the registration reject message, the AMF being associated with a VPLMN on which the terminal device intends to camp; and means for determining that the registration reject message is to be transmitted to the terminal device.

In a fourteenth aspect, there is provided an apparatus comprising means for receiving, from a UDM function, that an indication that a SoR update is supported in the registration reject message; and means for, in accordance with a determination that the registration reject message is to be transmitted to a terminal device, providing, to the UDM, at least one recommended VPLMN to be camped on by the terminal device.

In a fifteenth aspect, there is provided an apparatus comprising means for transmitting, to an AMF, an authentication response including a request of acknowledgement, SoR information and a MAC-I of a home network.

In a sixteenth aspect, there is provided a computer readable medium having a computer program stored thereon which, when executed by at least one processor of an apparatus, causes the apparatus to carry out the method according to the sixth aspect, the seventh aspect, the eighth aspect, the ninth aspect or the tenth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIG. 3 shows a signaling chart illustrating an example of process according to some example embodiments of the present disclosure;

FIG. 4 shows a flowchart of an example method of SoR enhancement during registration reject according to some example embodiments of the present disclosure;

FIG. 5 shows a flowchart of an example method of SoR enhancement during registration reject according to some example embodiments of the present disclosure;

FIG. 6 shows a flowchart of an example method of SoR enhancement during registration reject according to some example embodiments of the present disclosure;

FIG. 7 shows a flowchart of an example method of SoR enhancement during registration reject according to some example embodiments of the present disclosure;

FIG. 8 shows a flowchart of an example method of SoR enhancement during registration reject according to some example embodiments of the present disclosure;

FIG. 9 shows a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a remote radio head (RRH), a relay, an Integrated Access and Backhaul (JAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

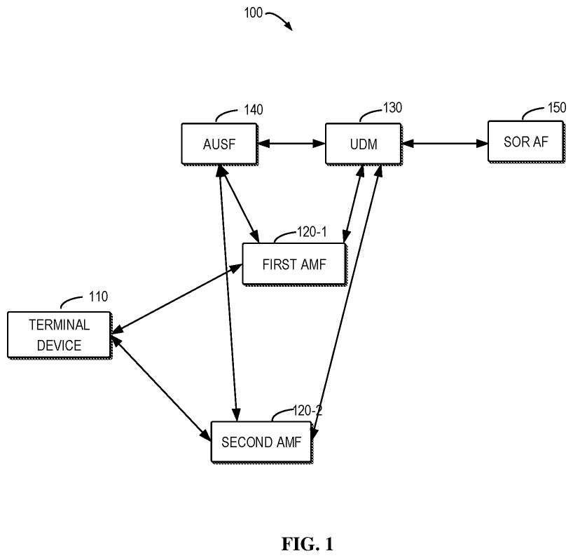

FIG. 1 shows an example communication environment 100 in which embodiments of the present disclosure can be implemented. As shown in FIG. 1, the communication environment 100 may comprise a terminal device 110. Hereinafter the terminal device 110 may also be referred to as a User Equipment (UE).

The communication environment 100 may further comprise multiple core network (CN) nodes. For example, the communication environment 100 may comprise a first AMF 120-1 (which may also be referred to an AMF in the present disclosure) and a second AMF 120-2 (which may also be referred to a further AMF in the present disclosure). The first AMF 120-1 and the second AMF 120-2 may be associated with different VPLMNs.

The AMF may receive all connection and session related information from UE and be responsible for handling connection and mobility management tasks. The UE may specify a Globally Unique AMF Identifier (GUAMI) in the first Non-Access Stratum (NAS) message it sends, which is routed to the required AMF by the Radio Access Network (RAN). Furthermore, the AMF may also be in charge of managing handovers between gNBs within the Next Generation Radio Access Network (NG-RAN).

The communication environment 100 may further comprise an Authentication Server Function (AUSF) 140, which may be responsible for the security procedure for the authentication. For example, the AMF 120-1 (acts a service consumer) may request, to the AUSF 140 (acts as a service provider), the authentication of UEs by providing information associated with the terminal device 110. The AUSF may provide one or more keys to for the authentication of the terminal device 110.

Moreover, the communication environment 100 may further comprise a UDM 130. The UDM 130 may be responsible for an AKA authentication Credentials, an access authorization based on subscription data (e.g., roaming restrictions) and serving NF Registration Management of terminal devices. For example, the AUSF 140 (acts as a service provider) may provide a SoR MAC-I_{AUSF} to the UDM 130 (acts a service consumer) via a SoR protection service. to protect information list from being tampered with or deleted by VPLMN.

The communication environment 100 may further comprise an Application Function (AF), such as SoR AF 150, which may communicate with the UDM 130. For example, the SoR AF may offer a SoR Service to UDM 130 (acts a service consumer) via the Nsoraf service-based interface, to enable the retrieval of SoR information to be conveyed to the terminal device 110.

It is to be understood that the number of network nodes and terminal devices shown in FIG. 1 is given for the purpose of illustration without suggesting any limitations. The communication environment 100 may include any suitable number of network nodes and terminal devices.

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, RVAS may be consumed by roaming subscribers or by the home network of the roaming subscribers and the discussion of RVAS may focus on RVAS enabled by the PLMN for 5GS roaming. There are several use cases of RVAS in 5GS enabled by the PLMN, such as welcome Short Message Service (SMS), SoR during the registration procedure and International Mobile Subscriber Identity (IMSI) based routing to a particular core network, etc.

Home public land mobile networks (HPLMNs) may steer their subscribers to preferred partner networks in case of roaming by means of issuing commands and updating the Operator Controlled PLMN selector list on the Universal Subscriber Identity Module (USIM), either by using SMS or via signalling.

Additionally, for more short-term balancing of distribution across VPLMNs, operators use mechanisms to reject registration attempts from some share of UEs to certain VPLMNs to make them select a different VPLMN.

Both mechanisms, namely SoR as defined in 3GPP and the here described SoR during the registration procedure, may be applied in parallel by a HPLMN.

This use case to be described below may explain how the home operator identifies that a roaming user attempts to register in a new network and triggers the sending of reject messages to the UE, resulting in the UE attempting to register to another VPLMN.

For example, users X and Y have a subscription with operator HPLMN1. Both users X and Y are travelling to another country, where two networks are available, i.e., VPLMN1 and VPLMN2. Both networks have a roaming agreement with HPLMN1. VPLMN1 has a higher priority for both users.

When users X and Y arrive at the country and switch on their UEs, both UEs may select VPLMN1 as their first choice for registration and try to register on that network. VPLMN1 forwards the registration request messages of the UEs of users X and Y to the HPLMN1. The HPLMN1 may recognize the registration attempts and invokes the steering service via a northbound API. The steering service, hosted by the HPLMN or some trusted 3rd party, decides if some steering action is needed for any of the UEs. In this use case it decides to allow the UE of user X to register on VPLMN1 whereas the UE of user Y should not use VPLMN1.

The steering service may trigger the steering action using the northbound application programming interface (API) for the UE of user Y, which results in a reject message being sent to the UE of user Y, including an appropriate reason for the rejection. The registration process for the UE of user Y is not affected.

While the UE of user X successfully registered to VPLMN1, the UE of user Y may select VPLMN2 as the only other available network and registers there. If more than one remaining VPLMN is available, the UE of user Y may pick one of them according to network selection procedures. The process of rejecting could be repeated as needed.

In the use case as described above, during the initial registration, if an authentication is not completed or authentication is rejected (or registration is rejected), then the UE does not have a latest KAUSF. In this scenario, the UE may not perform an integrity protection check, i.e., the UE cannot generate MAC.

Therefore, if a SoR container (i.e., SoR information) is sent in the registration reject, the UE may not perform an integrity protection check over the SoR container and the SoR data may be tampered.

Furthermore, if the SoR is sent in the registration reject, then another problem of Acknowledgement (ACK) may arise. i.e., if the UDM has requested UE to send the ACK for SoR data, how the UE will send the ACK in a case wherein the UE connection with network is closed after registration reject. Without the ACK, the UDM may assume that ACK is not received and mark the PLMN as not trusted. Therefore, if the SoR is sent in the registration reject, then there should be a way defined for the UE to send the ACK back to the UDM.

Therefore, embodiments of the present disclosure propose a mechanism of SoR enhancement during registration reject. In this solution, the terminal device 110 transmits, to an AMF associated with a VPLMN on which the apparatus intends to camp, a registration request at least indicating that a SoR update is supported in a registration reject message and receives, from the AMF, the registration reject message including a request of ACK, SoR information and a MAC-I of a home network.

Example embodiments of the present disclosure will be described in detail below with reference to the accompanying drawings.

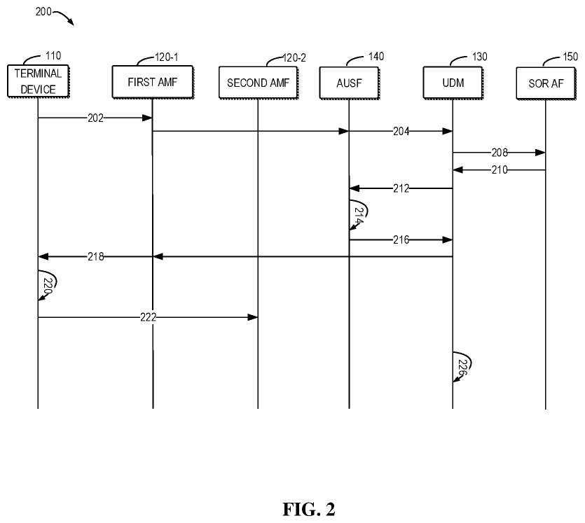

In some scenarios, the SoR information may be included during an initial registration/authentication reject of the terminal device 110, which may be described with reference to FIG. 2 as below.

Reference is now made to FIG. 2, which shows a signaling chart 200 for communication according to some example embodiments of the present disclosure. As shown in FIG. 2, the signaling chart 200 involves the terminal device 110, the first AMF 120-1, the second AMF 120-2, the AUSF 140, the UDM 130 and the SoR AF 150. For the purpose of discussion, reference is made to FIG. 1 to describe the signaling chart 200.

The AMF 120-1 may be associated with a first VPLMN and the AMF 120-2 may be associated with a second VPLMN.

As shown in FIG. 2, the terminal device 110 may transmit (202) a registration request to the AMF 120-1 to camp on the first VPLMN. The registration request may at least indicate that the SoR update is supported in the registration reject message. For example, the SoR update is supported in the registration reject message may be indicated by a flag in the registration request. It is also possible that the flag may also indicate that the support of SoR update in registration reject message is not set. This flag may differentiate between UEs not supporting this new feature and UEs supporting this new feature at UDM 130 whether SoR container (i.e., SoR information) in registration reject message is accepted or not.

The AMF 120-1 may transmit (204), via the AUSF 140 and to the UDM 130, the authentication request with the same flag indicating the support of SoR update in registration reject message. Then the UDM 130 may store the UE capability, i.e., the support of SoR update in registration reject message.

Then the UDM 130 may inform (208) the authentication request with the UE capability to the SoR AF 150. The SoR AF 150 may provide (210) to the UDM 130 with a secured packet at least including a list of recommended VPLMNs and ask to send it in the registration reject message. Alternatively, the UDM 130 may also generate one or more recommended VPLMNs for the SoR information, which may be provided in the registration reject message as secured packet.

Furthermore, the UDM 130 may also inform (212) the AUSF 140 that the SoR information is to be sent in the registration reject message. Then the AUSF 140 may generate (214) a MAC-I of the home network, i.e., the MAC-I_{HN} and provide (216) it to the UDM 130. The details about how to generate the MAC-I_{HN} may be described later.

The SoR information is integrity protected based on the generated MAC-I_{HN}. If the ACK is expected from the terminal device 110, the generated MAC-I_{HN} may store for later verification.

Then the UDM 130 may transmit (218) the registration reject message to the terminal device 110 as the first VPLMN is not the recommended VPLMN on which the terminal device should camp. This registration reject message transmitted (218) from the UDM 130 may first reach to AMF 120-1, then the AMF 120-1 may send the registration reject message to the terminal device 110. The registration reject message may comprise at least one recommend VPLMN and other parameters such as a request for ACK, the SoR information and the MAC-I_{HN}.

Since the UDM 130 expects the terminal device 110 to respond back ACK in the next registration procedure that may or may not happen immediately, the UDM 130 may store the expected MAC-I_{HN} in the UDR storage and wait for the next registration procedure.

Since the supporting of SoR update, the terminal device 110 may accept the SoR data in the registration reject message and the integrity protection is verified for the received SoR information based on the MAC-I_{HN}. The secured packet is sent to USIM for de-concealment and storage. The USIM stored the received recommended VPLMNs.

The terminal device 110 may further generate (220) a MAC-I_{UE} for the SoR ACK. The details about how to generate the MAC-I_{UE} may be described later.

Then the terminal device 110 may transmit (222) a next registration request, for example, to the AMF 120-2 associated with a recommend VPLMN (i.e., the second VPLMN) on which the terminal device is to camp. The next registration request may comprise a SoR ACK and a generated MAC-I_{UE}.

Then the AMF 120-2 may forward (224) the SoR ACK and a generated MAC-I_{UE} along with an authentication request to the UDM 130.

After the UDM 130 receives the new SoR ACK, the UDM 130 may verify (226) the received MAC-I_{UE} with stored expected MAC-I_{HN}. The UDM 130 may generate an Authentication and Key Agreement (AKA) challenge for this attempted registration request, as the terminal device 110 has successfully tried to register on recommended VPLMN.

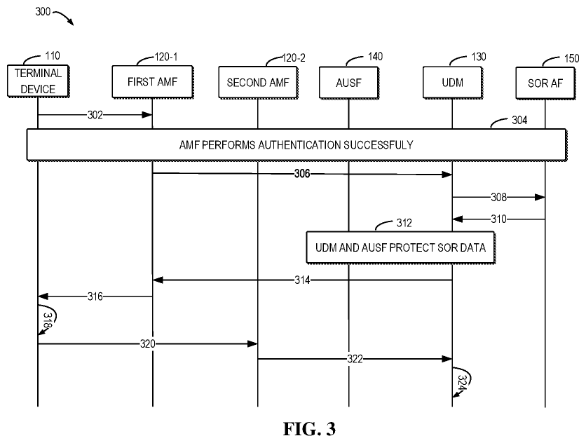

Reference is now made to FIG. 3, which shows a signaling chart 300 for communication according to some example embodiments of the present disclosure. As shown in FIG. 3, the signaling chart 300 involves the terminal device 110, the first AMF 120-1, the second AMF 120-2, the AUSF 140, the UDM 130 and the SoR AF 150. For the purpose of discussion, reference is made to FIG. 1 to describe the signaling chart 300.

The AMF 120-1 may be associated with a first VPLMN and the AMF 120-2 may be associated with a second VPLMN.

Similar as the signaling chart 200, as shown in FIG. 3, the terminal device 110 may transmit (302) a registration request to the AMF 120-1 to camp on the first VPLMN. The registration request may at least indicate that the SoR update is supported in the registration reject message. For example, the SoR update is supported in the registration reject message may be indicated by a flag in the registration request. It is also possible that the flag may also indicate that the support of SoR update in registration reject message is not set. This flag may differentiate between UEs not supporting this new feature and UEs supporting this new feature at UDM 130 whether SoR container (i.e., SoR information) in registration reject message is accepted or not.

If the AMF 120-1 performs (304) the authentication successfully, the AMF 120-1 may also transmit, to the UDM 130, an authentication request or a registration request with the same flag indicating the support of SoR update in registration reject message. Then the UDM 130 may store the UE capability, i.e., the support of SoR update in registration reject message.

Then the AMF 120-1 may transmit (306), to the UDM 130, a user equipment context management (UECM) registration request (i.e., Nudm_UECM_Registration) indicating the support of SoR update in registration reject message.

The UDM 130 may then ask (308) the SoR AF 150 to generate the SoR information with a list of recommended VPLMNs for the terminal device 110 and this SoR information may be provided (310) as secured packet from the SoR AF 150 to UDM 130. The SoR AF 150 may ask the UDM 130 to send the SoR information in the registration reject message.

As the authentication is performed successfully, the terminal device and network may have KAUSF stored, therefore the normal SoR procedure will be sufficient and the AUSF 140 may perform (312) the integrity protection of the SoR information, for example, by generating a MAC-I_{HN} based on the K_{AUSF}. If the ACK is expected from the terminal device 110, the generated MAC-I_{HN} may store for later verification.

The UDM 130 may reject the current registration as asked by the SoR AF 150. The UDM 130 may transmit (314), to the AMF 120-1, the registration reject message containing parameters like a request for ACK, the SoR information and the MAC-I_{HN}. Then the AMF 120-1 may forward (316) the registration reject message to the terminal device 110.

The UDM 130 may expect the terminal device 110 to respond back ACK in the next registration procedure (associated with a same VPLMN or a new VPLMN) that may or may not happen immediately. The UDM 130 may store the expected MAC-I_{HN} in the UDR storage and wait for the next registration procedure.

Since the supporting of SoR update, the terminal device 110 may accept the SoR data in the registration reject message and the integrity protection is verified for the received SoR information based on the MAC-I_{HN}. The secured packet is sent to USIM for de-concealment and storage. The USIM stored the received recommended VPLMNs.

The terminal device 110 may further generate (318) a MAC-I_{UE} for the SoR ACK. The details about how to generate the MAC-I_{UE} may be described later.

Then the terminal device 110 may transmit (320) a next registration request, for example, to the AMF 120-2 associated with a recommend VPLMN (i.e., the second VPLMN) on which the terminal device is to camp. The next registration request may comprise a SoR ACK and a generated MAC-I_{UE}. Alternatively, the terminal device 110 may transmit a next registration request to the AMF 120-1.

Then the AMF 120-2 may forward (322) the SoR ACK and a generated MAC-I_{UE} along with an authentication request or a registration request to the UDM 130/a home network.

After the UDM 130 receives the new SoR ACK, the UDM 130 may verify (324) the received MAC-I_{UE} with stored expected MAC-I_{HN}.

In this way, the SoR data may be sent via a registration reject message and the SoR data is integrity protected via new keys. Furthermore, the UE may send the ACK via another registration (the next registration) and the network may wait and accept the same.

Hereinafter, embodiments for generation the MAC-I of the home network and the terminal device may further be described as below.

For example, the UDM and USIM has been provisioned with long term key K, which may be used for the MAC-I_{HN} generation during initial registration procedure at USIM and in the UDM.

Furthermore, the generation of the MAC-I_{HN} may also be based on an Integrity Key (IK). When the initial registration request is received in UDM and if that is not a recommended VPLMN, then an Authentication Token (AUTN) is generated. No RES or K_{AUSF} keys will be generated during AUTN generation. During the AUTN generation, IK is generated. The AUTN may be sent in registration reject message to the terminal device.

As another option, the UDM and USIM may generate Steering of Roaming key, i.e., K_{SoR} as a derived key from long term key with new RAND. This RAND may be sent in registration reject message by the UDM to the terminal device. The terminal device may use this RAND and long term key to generate the K_{SoR} key. This derived key K_{SoR} may be used in MAC-I generation in UDM and UE.

It is also possible that the UDM and USIM may store the previous K_{AUSF} during de-registration of the terminal device. During the next registration, till security context is established, this old or previous K_{AUSF} can be used between the terminal device and the home network.

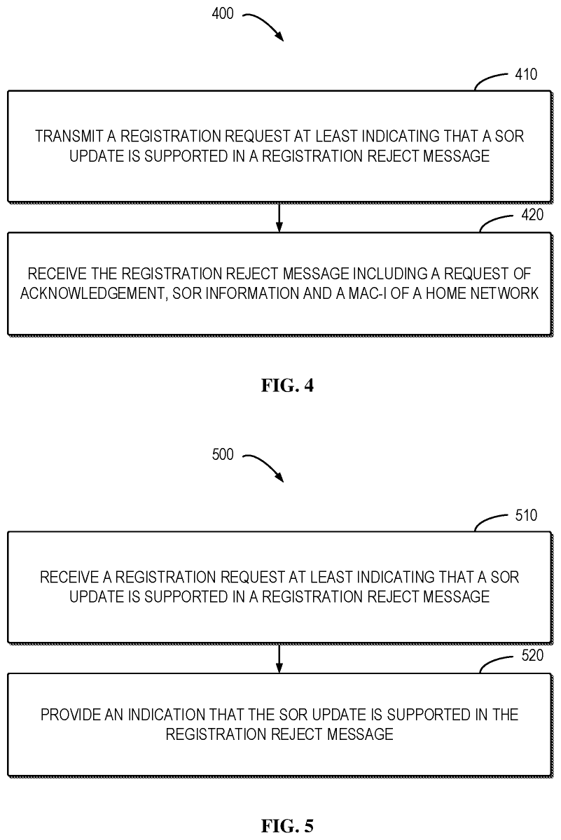

FIG. 4 shows a flowchart of an example method 400 of SoR enhancement during registration reject according to some example embodiments of the present disclosure. The method 400 may be implemented at the terminal device 410 as shown in FIG. 1. For the purpose of discussion, the method 400 will be described with reference to FIG. 1.

At 410, the terminal device 110 transmits, from a terminal device to an AMF, a registration request at least indicating that a SoR update is supported in a registration reject message, the AMF being associated with a VPLMN on which the terminal device intends to camp.

At 420, the terminal device 110 receives the registration reject message including a request of acknowledgement, SoR information and a MAC-I of a home network.

In some example embodiments, the SoR update is supported in the registration reject message is indicated by a flag in the registration request.

In some example embodiments, the registration reject message is received during an initial registration procedure or an authentication procedure of the terminal device.

In some example embodiments, the SoR information contains at least one recommended VPLMN to be camped on by the terminal device.

In some example embodiments, the terminal device may verify the SoR information for an integrity protection based on the MAC-I of the home network.

In some example embodiments, the terminal device may generate a MAC-I of the terminal device for a SoR acknowledgement.

In some example embodiments, the MAC-I of the terminal device is generated based on at least one of: a long term key, an integrity key, a SoR key, or a previous K_{AUSF}.

In some example embodiments, the terminal device may store the previous K_{AUSF} in a previous registration procedure till a security context is established during a next registration procedure.

In some example embodiments, the terminal device may transmit, to the AMF or a further AMF, a further registration request at least indicating the SoR acknowledgement and the generated MAC-I of the terminal device, the further AMF being associated with a recommended VPLMN to be camped on by the terminal device.

FIG. 5 shows a flowchart of an example method 500 of SoR enhancement during registration reject according to some example embodiments of the present disclosure. The method 500 may be implemented at the first AMF 120-1 as shown in FIG. 1. For the purpose of discussion, the method 500 will be described with reference to FIG. 1.

At 510, the first AMF 120-1 receives, at an AMF and from a terminal device, a registration request at least indicating that a SoR update is supported in a registration reject message, the AMF being associated with a VPLMN on which the terminal device intends to camp.

At 520, the first AMF 120-1 provides, to a UDM function, an indication that the SoR update is supported in the registration reject message.

In some example embodiments, the indication that the SoR update is supported in the registration reject message is provided from the first AMF to the UDM function in an authentication request or in a user equipment context management, UECM, registration request.

In some example embodiments, the SoR update is supported in the registration reject message is indicated by a flag in the authentication request or in the user equipment context management, UECM, registration request.

In some example embodiments, the indication is provided from the first AMF to the UDM function in the authentication request via an authentication server function, AUSF.

In some example embodiments, the first AMF 120-1 may receive, from the UDM function, a request of acknowledgement, SoR information and a message authentication code-integrity, MAC-I of a home network via an error indication for the UECM registration request or the authentication request; and transmit, to the terminal device, the registration reject message including the request of acknowledgement, the SoR information and the message authentication code-integrity, MAC-I of the home network.

In some example embodiments, the first AMF 120-1 may receive, from the terminal device, a further registration request at least indicating the SoR acknowledgement and a MAC-I of the terminal device; and forward the further registration request to the UDM function.

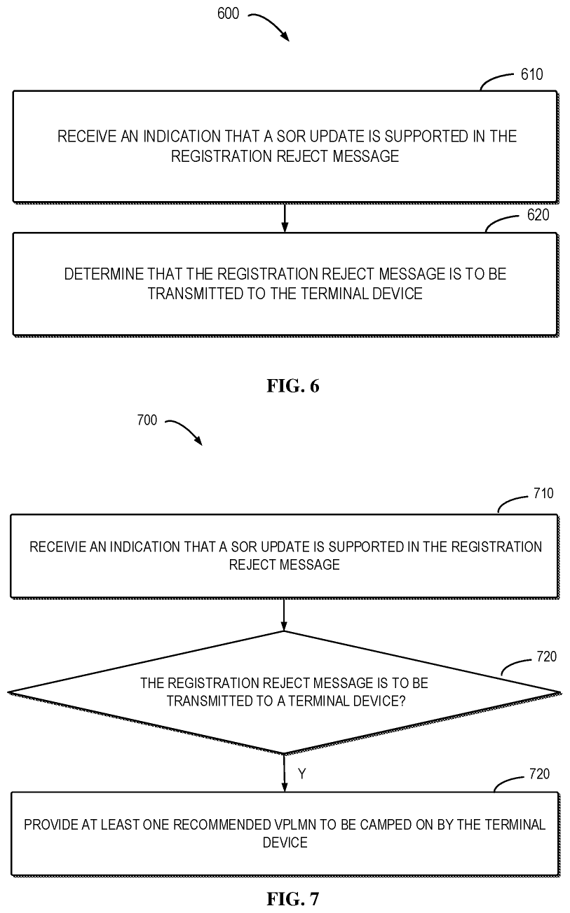

FIG. 6 shows a flowchart of an example method 600 of SoR enhancement during registration reject according to some example embodiments of the present disclosure. The method 600 may be implemented at the UDM 130 as shown in FIG. 1. For the purpose of discussion, the method 600 will be described with reference to FIG. 1.

At 610, the UDM 130 receives, at a UDM and from an AMF, an indication that a SoR update is supported in the registration reject message, the AMF being associated with a VPLMN on which the terminal device intends to camp.

At 620, the UDM 130 determines that the registration reject message is to be transmitted to the terminal device.

In some example embodiments, the indication that the SoR update is supported in the registration reject message is provided from the AMF to the UDM in an authentication request or in a user equipment context management registration request.

In some example embodiments, the indication is provided from the AMF to the UDM in the authentication request via an authentication server function, AUSF.

In some example embodiments, the UDM may generate at least one recommended VPLMN to be camped on by the terminal device, or inform a SoR application function that the SoR update is supported in the registration reject message and obtain, from the SoR application function, at least one recommended VPLMN to be camped on by the terminal device.

In some example embodiments, the UDM may inform the AUSF that SoR information is to be transmitted in the registration reject message.

In some example embodiments, the UDM may transmit, to the AMF, a request of acknowledgement, SoR information and a message authentication code-integrity, MAC-I of a home network via an error indication for the user equipment context management registration request.

In some example embodiments, the UDM may transmit, to the AMF, a request of acknowledgement, SoR information and a message authentication code-integrity, MAC-I of a home network via an error indication for the authentication request.

In some example embodiments, the UDM may receive, from the AMF or a further AMF, a further user equipment context management, UECM, registration request or a further authentication request at least indicating the SoR acknowledgement and a MAC-I of the terminal device, the further AMF being associated with a recommended VPLMN to be camped on by the terminal device.

In some example embodiments, the further UECM registration request indicates that SoR indication is supported in the registration reject message.

FIG. 7 shows a flowchart of an example method 700 of SoR enhancement during registration reject according to some example embodiments of the present disclosure. The method 700 may be implemented at the SoR AF 150 as shown in FIG. 1. For the purpose of discussion, the method 700 will be described with reference to FIG. 1.

At 710, the SoR AF 150 receives, at a SoR application and from a UDM function, that an indication that a SoR update is supported in the registration reject message.

At 720, if the SoR AF 150 determines that the registration reject message is to be transmitted to a terminal device, at 730, the SoR AF 150 provides, to the UDM, at least one recommended VPLMN to be camped on by the terminal device.

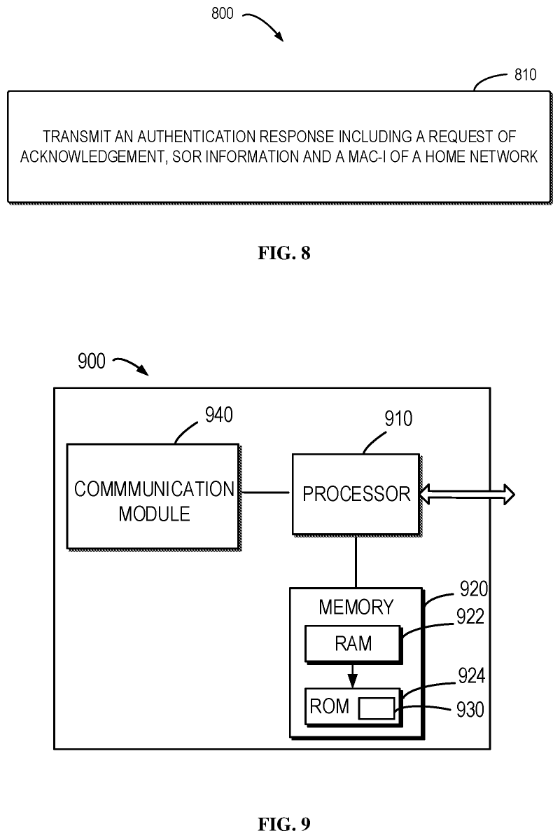

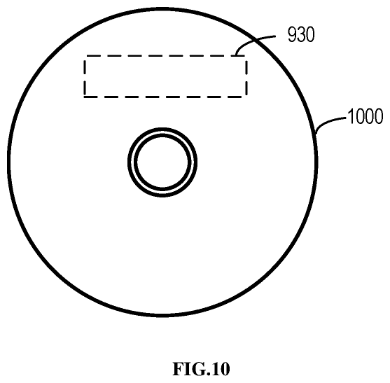

FIG. 8 shows a flowchart of an example method 800 of SoR enhancement during registration reject according to some example embodiments of the present disclosure. The method 800 may be implemented at the AUSF 140 as shown in FIG. 1. For the purpose of discussion, the method 800 will be described with reference to FIG. 1.

At 810, the AUSF 140 transmits, from an AUSF to an AMF, an authentication response including a request of acknowledgement, SoR information and a MAC-I of a home network.

In some example embodiments, in accordance with a determination that a unified data management, UDM, function, the AUSF 140 may inform that the SoR information is to be transmitted in the registration reject message, cause the SoR information to be integrity protected; and generate the MAC-I of a home network.

In some example embodiments, the MAC-I of the home network is generated based on at least one of: a long term key, an integrity key, a SoR key, or a previous K_{AUSF}.

In some example embodiments, the AUSF 140 may store the previous K_{AUSF} in a previous registration procedure till a security context is established during a next registration procedure.

In some example embodiments, the AUSF 140 may receive, from an access and mobility management function, AMF, an authentication request at least indicating that a SoR update is supported in the registration reject message, the AMF being associated with a visited public land mobile network, VPLMN, on which the terminal device intends to camp; and forward the authentication request to a unified data management, UDM, function.

In some example embodiments, the AUSF 140 may receive, from a further AMF, a further authentication request at least indicating the SoR acknowledgement and a MAC-I of the terminal device, the further AMF being associated with a recommended VPLMN to be camped on by the terminal device.

In some example embodiments, an apparatus capable of performing the method 400 (for example, implemented at the terminal device 110) may include means for performing the respective steps of the method 400. The means may be implemented in any suitable form. For example, the means may be implemented in a circuitry or software module.

In some example embodiments, the apparatus comprises means for transmitting, to an AMF, a registration request at least indicating that a SoR update is supported in a registration reject message, the AMF being associated with a VPLMN on which the apparatus intends to camp; and means for receiving the registration reject message including a request of acknowledgement, SoR information and a MAC-I of a home network.

In some example embodiments, the SoR update is supported in the registration reject message is indicated by a flag in the registration request.

In some example embodiments, the registration reject message is received during an initial registration procedure or an authentication procedure of the apparatus.

In some example embodiments, the SoR information contains at least one recommended VPLMN to be camped on by the apparatus.

In some example embodiments, the apparatus may also comprise means for verifying the SoR information for an integrity protection based on the MAC-I of the home network.

In some example embodiments, the apparatus may also comprise means for generating a MAC-I of the apparatus for a SoR acknowledgement.

In some example embodiments, the MAC-I of the apparatus is generated based on at least one of: a long term key, an integrity key, a SoR key, or a previous K_{AUSF}.

In some example embodiments, the apparatus may also comprise means for storing the previous K_{AUSF} in a previous registration procedure till a security context is established during a next registration procedure.

In some example embodiments, the apparatus may also comprise means for transmitting, to the AMF or a further AMF, a further registration request at least indicating the SoR acknowledgement and the generated MAC-I of the apparatus, the further AMF being associated with a recommended VPLMN to be camped on by the apparatus.

In some example embodiments, an apparatus capable of performing the method 500 (for example, implemented at the AMF 120-1) may include means for performing the respective steps of the method 500. The means may be implemented in any suitable form. For example, the means may be implemented in a circuitry or software module.

In some example embodiments, the apparatus comprises means for receiving, from a terminal device, a registration request at least indicating that a SoR update is supported in a registration reject message, the apparatus being associated with a VPLMN on which the terminal device intends to camp; and means for providing, to a UDM function, an indication that the SoR update is supported in the registration reject message.

In some example embodiments, the indication that the SoR update is supported in the registration reject message is provided from the apparatus to the UDM function in an authentication request or in a user equipment context management, UECM, registration request.

In some example embodiments, the SoR update is supported in the registration reject message is indicated by a flag in the authentication request or in the user equipment context management, UECM, registration request.

In some example embodiments, the indication is provided from the apparatus to the UDM function in the authentication request via an authentication server function, AUSF.

In some example embodiments, the apparatus may also comprise means for receiving, from the UDM function, a request of acknowledgement, SoR information and a message authentication code-integrity, MAC-I of a home network via an error indication for the UECM registration request or the authentication request; and means for transmitting, to the terminal device, the registration reject message including the request of acknowledgement, the SoR information and the message authentication code-integrity, MAC-I of the home network.

In some example embodiments, the apparatus may also comprise means for receiving, from the terminal device, a further registration request at least indicating the SoR acknowledgement and a MAC-I of the terminal device; and means for forwarding the further registration request to the UDM function.

In some example embodiments, an apparatus capable of performing the method 600 (for example, implemented at the UDM 130) may include means for performing the respective steps of the method 600. The means may be implemented in any suitable form. For example, the means may be implemented in a circuitry or software module.

In some example embodiments, the apparatus comprises means for receiving, from an AMF, an indication that a SoR update is supported in the registration reject message, the AMF being associated with a VPLMN on which the terminal device intends to camp; and means for determining that the registration reject message is to be transmitted to the terminal device.

In some example embodiments, the indication that the SoR update is supported in the registration reject message is provided from the AMF to the apparatus in an authentication request or in a user equipment context management registration request.

In some example embodiments, the indication is provided from the AMF to the apparatus in the authentication request via an authentication server function, AUSF.

In some example embodiments, the apparatus may also comprise means for generating at least one recommended VPLMN to be camped on by the terminal device, or means for informing a SoR application function that the SoR update is supported in the registration reject message and means for obtaining, from the SoR application function, at least one recommended VPLMN to be camped on by the terminal device.

In some example embodiments, the apparatus may also comprise means for informing the AUSF that SoR information is to be transmitted in the registration reject message.

In some example embodiments, the apparatus may also comprise means for transmitting, to the AMF, a request of acknowledgement, SoR information and a message authentication code-integrity, MAC-I of a home network via an error indication for the user equipment context management registration request.

In some example embodiments, the apparatus may also comprise means for transmitting, to the AMF, a request of acknowledgement, SoR information and a message authentication code-integrity, MAC-I of a home network via an error indication for the authentication request.

In some example embodiments, the apparatus may also comprise means for receiving, from the AMF or a further AMF, a further user equipment context management, UECM, registration request or a further authentication request at least indicating the SoR acknowledgement and a MAC-I of the terminal device, the further AMF being associated with a recommended VPLMN to be camped on by the terminal device.

In some example embodiments, the further UECM registration request indicates that SoR indication is supported in the registration reject message.

In some example embodiments, an apparatus capable of performing the method 700 (for example, implemented at the SoR AF 150) may include means for performing the respective steps of the method 700. The means may be implemented in any suitable form. For example, the means may be implemented in a circuitry or software module.

In some example embodiments, the apparatus comprises means for receiving, from a UDM function, that an indication that a SoR update is supported in the registration reject message; and means for, in accordance with a determination that the registration reject message is to be transmitted to a terminal device, providing, to the UDM, at least one recommended VPLMN to be camped on by the terminal device.

In some example embodiments, an apparatus capable of performing the method 800 (for example, implemented at the AUSF 140) may include means for performing the respective steps of the method 800. The means may be implemented in any suitable form. For example, the means may be implemented in a circuitry or software module.

In some example embodiments, the apparatus comprises means for transmitting, to an AMF, an authentication response including a request of acknowledgement, SoR information and a MAC-I of a home network.

In some example embodiments, the apparatus may also comprise means for in accordance with a determination that a unified data management, UDM, function, informing that the SoR information is to be transmitted in the registration reject message, cause the SoR information to be integrity protected; and generating the MAC-I of a home network.

In some example embodiments, the MAC-I of the apparatus is generated based on at least one of: a long term key, an integrity key, a SoR key, or a previous K_{AUSF}.

In some example embodiments, the apparatus may also comprise means for storing the previous K_{AUSF} in a previous registration procedure till a security context is established during a next registration procedure.

In some example embodiments, the apparatus may also comprise means for receiving, from an access and mobility management function, AMF, an authentication request at least indicating that a SoR update is supported in the registration reject message, the AMF being associated with a visited public land mobile network, VPLMN, on which the terminal device intends to camp; and means for forwarding the authentication request to a unified data management, UDM, function.

In some example embodiments, the apparatus may also comprise means for receiving, from a further AMF, a further authentication request at least indicating the SoR acknowledgement and a MAC-I of the terminal device, the further AMF being associated with a recommended VPLMN to be camped on by the terminal device.

FIG. 8 is a simplified block diagram of a device 800 that is suitable for implementing example embodiments of the present disclosure. The device 800 may be provided to implement a communication device, for example, the terminal device 110, the first AMF 120-1, the second AMF 120-2, the AUSF 140, the UDM 130 and the SoR AF 150 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus at least to:
transmit, to an access and mobility management function, AMF, a registration request at least indicating that a steering of roaming, SoR, update is supported in a registration reject message, the AMF being associated with a visited public land mobile network, VPLMN, on which the apparatus intends to camp; and
receive the registration reject message including a request of acknowledgement, SoR information and a message authentication code-integrity, MAC-I, of a home network.

2. The apparatus of claim 1, wherein the SoR update is supported in the registration reject message is indicated by a flag in the registration request.

3. The apparatus of claim 1, wherein the registration reject message is received during an initial registration procedure or an authentication procedure of the apparatus.

4. The apparatus of claim 1, wherein the SoR information contains at least one recommended VPLMN to be camped on by the apparatus.

5. The apparatus of claim 1, wherein the apparatus is further caused to:
verify the SoR information for an integrity protection based on the MAC-I of the home network.

6. The apparatus of claim 1, wherein the apparatus is further caused to:
generate a MAC-I of the apparatus for a SoR acknowledgement.

7. The apparatus of claim 6, wherein the MAC-I of the apparatus is generated based on at least one of:
a long term key,
an integrity key,
a SoR key, or
a previous K_{AUSF}.

8. The apparatus of claim 7, wherein the apparatus is further caused to:
store the previous K_{AUSF} in a previous registration procedure till a security context is established during a next registration procedure.

9. The apparatus of claim 7, wherein the apparatus is further caused to:
transmit, to the AMF or a further AMF, a further registration request at least indicating the SoR acknowledgement and the generated MAC-I of the apparatus, the further AMF being associated with a recommended VPLMN to be camped on by the apparatus.

10. An apparatus comprising:
at least one processor; and
at least one memory storing instructions that, when executed by the at least one processor, cause the apparatus at least to:
receive, from a terminal device, a registration request at least indicating that a steering of roaming, SoR, update is supported in a registration reject message, the apparatus being associated with a visited public land mobile network, VPLMN, on which the terminal device intends to camp; and
provide, to a unified data management, UDM, function, an indication that the SoR update is supported in the registration reject message.

11. The apparatus of claim 10, wherein the indication that the SoR update is supported in the registration reject message is provided from the apparatus to the UDM function in an authentication request or in a user equipment context management, UECM, registration request.

12. The apparatus of claim 10, wherein the SoR update is supported in the registration reject message is indicated by a flag in the authentication request or in the UECM registration request.

13. The apparatus of claim 11, wherein the indication is provided from the apparatus to the UDM function in the authentication request via an authentication server function, AUSF.

14. The apparatus of claim 11, wherein the apparatus is further caused to:
receive, from the UDM function, a request of acknowledgement, SoR information and a message authentication code-integrity, MAC-I of a home network via an error indication for the UECM registration request or the authentication request; and
transmit, to the terminal device, the registration reject message including the request of acknowledgement, the SoR information and the message authentication code-integrity, MAC-I of the home network.

15. The apparatus of claim 10, wherein the apparatus is further caused to:
receive, from the terminal device, a further registration request at least indicating the SoR acknowledgement and a MAC-I of the terminal device; and
forward the further registration request to the UDM function.

16. An apparatus comprising:
at least one processor; and
at least one memory storing instructions that, when executed by the at least one processor, cause the apparatus at least to:
receive, from an access and mobility management function, AMF, an indication that a steering of roaming, SoR, update is supported in the registration reject message, the AMF being associated with a visited public land mobile network, VPLMN, on which the terminal device intends to camp; and
determine that the registration reject message is to be transmitted to the terminal device.

17. The apparatus of claim 16, wherein the indication that the SoR update is supported in the registration reject message is provided from the AMF to the apparatus in an authentication request or in a user equipment context management registration request.

18. The apparatus of claim 17, wherein the indication is provided from the AMF to the apparatus in the authentication request via an authentication server function, AUSF.

19. The apparatus of claim 16, wherein the apparatus is further caused to at least one of:
generate at least one recommended VPLMN to be camped on by the terminal device, or
inform a SoR application function that the SoR update is supported in the registration reject message, and
obtain, from the SoR application function, at least one recommended VPLMN to be camped on by the terminal device.

20. The apparatus of claim 18, wherein the apparatus is further caused to:
inform the AUSF that SoR information is to be transmitted in the registration reject message.
